(19) United States
(12) Patent Application Publication
(10) Pub. No.: US 2013/0086195 A1
(43) Pub. Date: Apr. 4, 2013

(54) DEVICE AND METHOD FOR ENABLING BACnet COMMUNICATION FOR WIRED AND WIRELESS DEVICES OPERABLE WITHIN A BUILDING AUTOMATION SYSTEM

(71) Applicant: Mark Hiniker, Round Lake Beach, IL (US)

(72) Inventor: Mark Hiniker, Round Lake Beach, IL (US)

(73) Assignee: Siemens Industry, Inc., Alpharetta, GA (US)

(21) Appl. No.: 13/248,678

(22) Filed: Sep. 29, 2011

(51) Int. Cl. G06F 15/16

(52) U.S. Cl. 709/208; 709/217

(57) ABSTRACT

An automation interface device is disclosed that provides interoperability between automation devices communicating within a building automation system. The device includes a communication interface receives a packet comprising a data envelope including a first destination address configured according to a first network protocol and a message including data configured according to a BACnet standard, and a processor in communication with a memory. The memory stores processor executable instructions configured to retrieve a second destination address configured according to a second network protocol from a routing table stored in the memory that correlates the second destination to the first destination address, generate a second packet comprising an second data envelope including the second destination address configured according to the second network protocol and the message including data configured according to the BACnet standard, and communicate, via the communication interface, the second packet to the second destination address.

### TECHNICAL FIELD

This patent document discloses and generally relates to communication within building automation systems, and more particularly to communication between wired and wireless automation devices operating according to different network protocols within a building automation system.

### BACKGROUND

A building automation system (BAS) typically integrates and controls elements and services within a structure such as the heating, ventilation and air conditions (HVAC) system, security services, fire systems and the like. The integrated and controlled systems are arranged and organized into one or more networks and/or sub-networks operating according to a common communication scheme and/or network protocol. These networks and sub-networks include and contain application or process specific controllers, sensors, actuators, or other devices wired or wirelessly coupled to the network for communication, power and/or control. The devices, elements or services utilized or incorporated into the building automation system are often manufactured and provided by different vendors and are adapted to accomplish different tasks and functions. The variety of device manufacturers and implementations often results in configuration and/or communication difficulties between devices operating according to different networking and communication protocols. Moreover, as networking protocols evolve over time, different product lines and classes of automation devices, elements or services may implement different versions of the same networking protocols.

### SUMMARY

This patent document discloses and generally relates to an automation interface device and interface methods configured to facilitate communication between wired and wireless automation device operating according to different network protocols within a building automation system.

The automation interface device and interface methods provide a mechanism by which communications, information and data between different building automation devices operating according to different network protocols can be exchanged. For example, two automation devices configured to operate according to a building automation and control network (BACnet) standard may implement different network protocols. The BACnet standard is supported and maintained by the American Society of Heating, Refrigerating and Air-Conditioning Engineers (ASHRAE). The network protocols that may be implemented according to the BACnet standard include, but are not limited to, a BACnet Master-Slave/Token-Passing (MS/TP) protocol, a BACnet ZigBee (IEEE 802.15.4) protocol and a BACnet Internet Protocol (IP).

In one embodiment, an automation interface device is configured to provide interoperability between two or more automation devices communicating within a building automation system is disclosed. The device includes a communication interface configured to receive a packet comprising a data envelope including a first destination address configured according to a first network protocol and a message including data configured according to a BACnet standard, and a processor in communication with a memory. The memory stores processor executable instructions configured to retrieve a second destination address configured according to a second network protocol from a routing table stored in the memory that correlates the second destination to the first destination address, generate a second packet comprising an second data envelope including the second destination address configured according to the second network protocol and the message including data configured according to the BACnet standard, and communicate, via the communication interface, the second packet to the second destination address.

In another embodiment, a method of interfacing between two or more automation devices communicating within a building automation system is disclosed. The method includes receiving a packet comprising a data envelope including a first destination address configured according to a first network protocol and a message including data configured according to a BACnet standard, determining, from a routing table stored in the memory, a second destination address configured according to a second network protocol and correlated to the first destination address, generating a second packet comprising an second data envelope including the second destination address configured according to the second network protocol and the message including data configured according to the BACnet standard, and communicating, via the communication interface, the second packet to the second destination address.

In yet another embodiment, a method of interfacing between two or more automation devices communicating within a building automation system is disclosed. The method includes receiving, at an automation interface device, a packet from a first automation device where the packet includes a data envelope having a first destination address configured according to a first network protocol and a message including data configured according to a BACnet standard, determining, at the automation interface device, a second destination address identifying a second automation device where the second destination address is configured according to a second network protocol and wherein the second destination address correlates to the first destination address, generating, at the automation interface device, a second packet comprising an second data envelope including the second destination address configured according to the second network protocol and the message including data configured according to the BACnet standard, and communicating the second packet to the second automation interface device at the second destination address.

In another embodiment, a method of interfacing between two or more automation devices communicating within a building automation system is disclosed. The method includes receiving a data envelope including a first destination address configured according to a BACnet MS/TP network protocol and a message including data configured according to a BACnet standard, retrieving a second destination address configured according to a BACnet ZigBee network protocol from a routing table such that the second destination address correlates to the first destination address, generating a second data envelope including the second destination address and the message including data configured according to the BACnet standard, and communicating, via the communication interface, the second data envelope to the second destination address.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an exemplary topology of a mixed protocol network configured to exchange information according to the teaching and disclosure provided herein;

FIG. 2 depicts an internal block diagram of an automation device and an automation interface configured to operate within the mixed protocol network shown in FIG. 1;

FIG. 3 illustrates controllers and control routines that can be utilized in the automation device and the automation interface shown in FIG. 2; and

FIGS. 4 to 7 depict flowcharts illustrating the operations that may be performed by the automation device and the automation interface shown in FIG. 2.

### DETAILED DESCRIPTION

This patent document discloses a system and methods that include an automation interface device and interface methods configured to facilitate communication between wired and wireless automation device operating according to different network protocols within a building automation system. The exemplary automation interface device and interface methods provide for and establish an interface by which building control communication, information and data can be exchanged between different building automation devices operating according to different network protocols can be exchanged. For example, a first automation device configured to operate according to a building automation and control network (BACnet) standard may implement a first network protocol can utilize the disclosed automation interface to exchange information with other BACnet compatible automation devices configured to implement a second network protocol.

The embodiments discussed herein include environmental control devices, building automation devices and wireless components. The embodiments may include automation devices configured to implement network protocols according to the BACnet standard that include, but are not limited to, a BACnet Master-Slave/Token-Passing (MS/TP) protocol, a BACnet ZigBee (IEEE 802.15.4) protocol and a BACnet Internet Protocol (IP). The automation devices and components may be, for example, one or more personal area network (PAN) coordinators implemented as a field panel (FPX or PXC); a full function device (FFD) implemented as a floor level device transceiver (FLNX); and a reduced function device (RFD) implemented as a wireless room temperature sensor (WRTS). Regardless of the specific type and functionality of any given device or component, compliance with the BACnet standard ensures that the information, data and commands adhere to a common format within the building automation system deployed throughout the structure or structures. However, the BACnet standard allows for different building automation networks to utilize different networking protocols that, in turn, may make it difficult to communicate and exchange data between different networks. The automation devices and components identified herein are provided as an example of environmental control devices, building automation components, wireless devices and transceivers that may be integrated and utilized within structure but are not intended to limit the type, functionality and interoperability of the devices and teaching discussed and claimed herein.

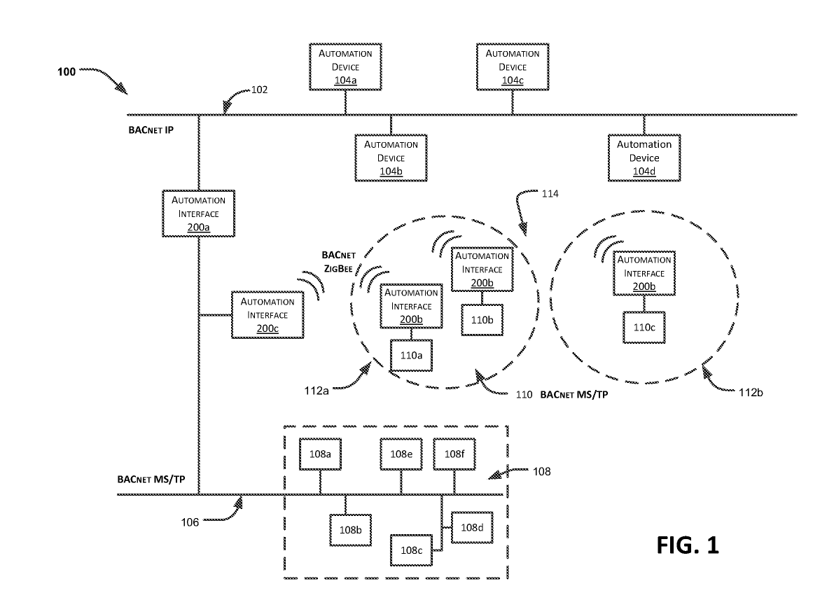

FIG. 1 illustrates an exemplary building automation system or control system 100 that may incorporate and implement the automation interface device and methods disclosed herein. The control system 100 includes a first network 102 such as an automation level network (ALN) or management level network (MLN) in communication with one or more automation devices 104 (individually identified as automation components 104a to 104d) and an automation interface device or automation interface 200a. The first network 102 may be a network operable according to the BACnet IP network protocol. Similarly, the one or more automation devices 104 may be configured to communicate according to the BACnet IP network protocol. In one embodiment, the automation interface or method of automation interface may be implemented as a PXC Modular field panel provided by Siemens Industry, Inc., Building Technologies Division (“Siemens”). The automation interface 200a may be a programmable device that couples the first network 102 to a second network 106 such as a floor level network (FLN).

The second network 106, in this exemplary embodiment, may be a network operable according to the Master-Slave/Token-Passing (MS/TP) network protocol. The second network 106 may include one or more automation devices 108 (individually identified as automation components 108a to 108f). The one or more automation devices 108a to 108f may be configured to communicate according to a wired BACnet MS/TP network protocol. The automation interface 200a may operate as an interface between the BACnet IP protocol configured automation devices 104 operable on first network 102 and the BACnet MS/TP protocol configured devices 108 operable on the second network 106.

The control system 100 may further include automation devices 110 (individually identified by the reference numerals 110a to 110c) grouped or arranged to establish subnets 112a and 112b. The automation devices 110a to 110c may be, for example, temperature sensors, damper actuators, lighting control devices and VAV controllers. In one example, the individual automation devices 110 operate according to the BACnet MS/TP network protocol, while the subnets 112a and 112b define a mesh network 114 operable according to the BACnet ZigBee network protocol. Accordingly, in this example, the automation interface 200b is directly coupled to the BACnet MS/TP protocol configured device 110a to allow for wireless information and data exchange between the BACnet MS/TP protocol configured device 110a and each of the remaining the BACnet MS/TP protocol configured devices 110b and 110c via the BACnet ZigBee compatible mesh network 114. Thus, each automation interface 200b allows a corresponding MS/TP compatible device 110 to interact with the ZigBee compatible network 114 and each other. The automation interface 200a can, in this way, operate as an interface router to direct communications between, for example, the BACnet MS/TP compatible devices 110 and the BACnet IP compatible devices 104. The automation interfaces 200c and 200b provide a similar mechanism by which MS/TP compatible automation devices 108 and 110 can communicate utilizing the BACnet ZigBee network 114. Hereinafter, the automation interfaces 200b are collectively identified as automation interface devices or automation interface 200.

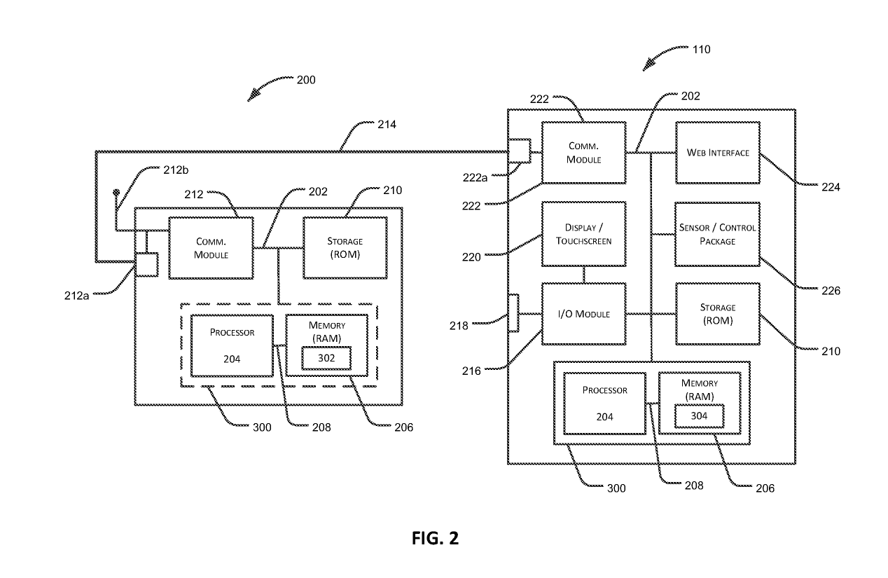

FIG. 2 illustrates an internal block diagram of the exemplary automation interface 200 directly coupled and/or wired to one of the automation devices 110 (e.g., the automation interface 200b coupled to automation device 110a, as shown in FIG. 1). In other embodiments, the automation interface 200 may be coupled to or in communication with automation devices 104 and 108 to provide similar access to the BACnet ZigBee compatible mesh network 114. The automation interface 200 includes the hardware, software and controls to facilitate communications and data exchange between automation devices operating according to different network protocols. The automation interface 200 may be a separate device in communication with the automation device 110 via a data connection 214. Alternatively, the automation interface 200 may be integral to the automation device 110 as an upgrade, plug-in card and the like.

The automation interface 200 is configured to receive, generate and communicate an exemplary packet comprising at least one data envelope and a message including building automation data between any one of the automation devices operable on, for example, the first network 102, the second network 106 and the mesh network 114. The internal block diagram representing the configuration of the automation interface 200 illustrates individual functions and/or modules as separate logical entities coupled via a bus 202. These logical entities may represent individual physical components that may be assembled as a part of a printed circuit board (PCB). Alternatively, these functions and modules may be integrated into a single or limited number of physical components. These functions and modules may each represent a specialized computer program or processor-executable code configured to convert a packet including a data envelope and a message. For example, the data envelope may be formatted according to a first network protocol and converted into a second data envelope formatted according to a second network protocol. Each of the packets contains and transports the same message and associated building automation data and commands. The message may include building automation data formatted for exchange and/or communication according to the BACnet standard.

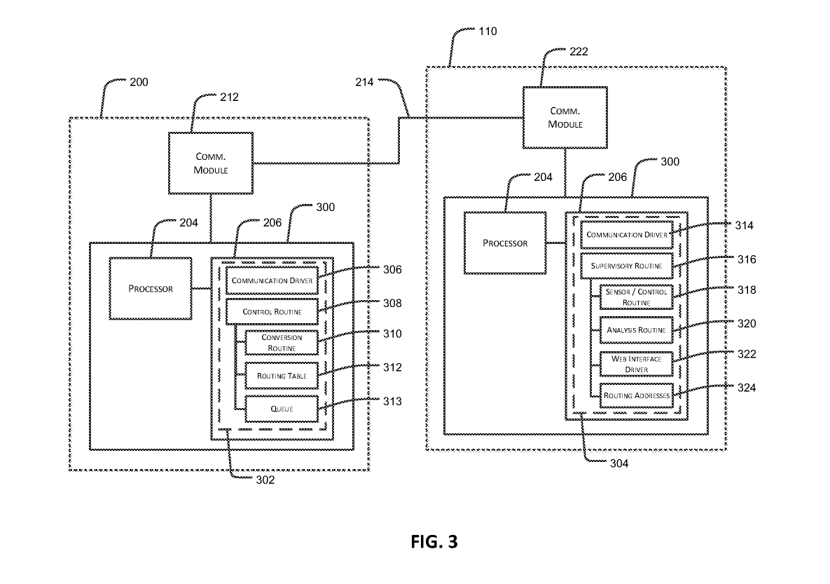

The automation interface 200 may include a controller 300 (see FIG. 3) comprising a processor 204 and a memory 206. In one embodiment or configuration, the processor 204 may be a computer processor configured to receive data, commands and/or instructions from the automation device 110 configured according to a first network protocol. The memory 206 may be volatile memory such as random access memory (RAM), static RAM (SRAM), dynamic RAM (DRAM) or any other memory accessible by the processor 204. The memory 206 may operate as a routing table, register, virtual memory and/or swap space for the processor 204. In this embodiment, the memory 206 stores an interface control routine 302 (see FIG. 3) for execution by the processor 204.

The controller 300, in another embodiment and configuration, may be an application-specific integrated circuit (ASIC) programmed and or customized to control and direct the operations automation interface 200. An exemplary ASIC may include an entire 32 or 64-bit processor, memory blocks including, but not limited to, read only memory (ROM), random access memory (RAM), electrically erasable programmable read-only memory (EEPROM), and flash memory. A purpose built and programmed ASIC could be utilized to replace the controller 300 including the processor 204 and memory 206.

In the present embodiment, the memory 206 and the processor 204 are arranged and configured to directly communicate with each other via a communication channel or dedicated bus 208. For example, the memory 206 may store an interface control routine 302 executable by the processor 204 and configured to direct the operation of the automation interface 200. In this configuration, the memory 206 and processor 204 that comprise the controller 300 define a self-contained control module capable of directing the operation of the automation interface 200. In another embodiment and configuration, the processor 204 is separate from and arranged to communicate with the memory 206 via the bus 202.

A secondary memory or storage module 210 accessible via the bus 202 may augment the memory 206. The secondary memory 210 may, in one embodiment, be directly accessible by the processor 204 or may be accessible though the memory 206. In the present embodiment, the secondary memory 210 defines a separate element and component from the controller 300; however, in other embodiments the secondary memory 210 may be an integral part of the controller 300 and/or memory 206. The storage module 210 may represent any known or later developed nonvolatile storage device such as, but not limited to, a hard drive, a solid-state drive (SSD), flash ROM (read-only memory) or an optical drive. The secondary memory 210 may be configured to accessibly store the information, data and executable files necessary to provide the desired functionality associated with the automation interface 200. In operation, the processor 204 may communicate with and access information on the secondary memory 210 via the bus 202.

A communication module 212 provides both wired or wireless communication capabilities that allow for communication with the communication module 222 of the exemplary automation devices 110. For example, a data connection 214 may be directly established between a communication port 212a of the automation interface 200 and a communication port 222a of the automation device 110. The data connection 214 can provide a wired and/or direct means by which the packet containing data, information and commands may be communicated from an automation device 110 that operates according to a first network protocol to an automation interface 200 configured to receive the packet. The automation interface 200, in turn, converts and reconfigures the packet from the first network protocol to a second network protocol. The resulting second packet can next be wirelessly communicated by the automation interface 200 to another automation device operating according to the second network protocol.

The communication ports 212a and 222a may accept an RS-485, RJ-45 or other connector in order to establish to the data connection 214. The automation device 110 may operate according to an MS/TP protocol such as a BACnet MS/TP protocol (see FIG. 1). The automation interface 200 may be configured to receive an MS/TP formatted packet and reconfigure it into a second packet according to a ZigBee protocol such as a BACnet ZigBee protocol for communication via a wireless transceiver 212b.

In one embodiment, the communication module 212 may be modified and configured to communicate according to IEEE 802.11 (Wi-Fi), IEEE 802.16 (WiMAX), IEEE 802.20 (wireless broadband), IEEE 802.15.4 (ZigBee), Bluetooth, or other known radio communications protocol, via the wireless transceiver 212b. The communications module 212 may be configured to operate as a dual-mode communication module in order to provide both wired and wireless communications for increased flexibility. Alternatively, or in addition to, the communication module 212, when operating as a dual-mode communication module, may send and receive information according to multiple wireless communication protocols. For example, the communication module 212 may be configured to simultaneously communicate information according to IEEE 802.11 (Wi-Fi) and IEEE 802.15.4 (ZigBee).

In this configuration, the communication module 212 may be coupled via the data connection 214 to the communication module 222 operable within the automation device 110. The automation device 110, as with the automation interface, includes a controller 300 and memory module 210 coupled to the communication module via a bus 202. Components, modules and elements common between the automation interface 200 and the automation device 110 are identified using common reference numerals. While these components, modules and elements may provide the same or similar functionality to the respective devices, the overall capabilities of these components may vary based on the tasks, operations and functions they are configured to perform.

The controller 300 utilized by the automation device 110, similar to the automation interface 200, includes a processor 204 and memory 206 configured to store a device control routine 304 executable by the processor 204. The device control routine 304 may, in turn, direct the operation and control the functionality of the automation device 110. The automation device 110 may include an I/O module 216 and connector 218 to couple to and communicate with one or more external devices, input devices and other peripherals. A touchscreen or display module 220 can control a display (not shown) according to instructions and commands received from the control routine 304. In another embodiment, the automation device 110 may include a web interface 224 that cooperates with the communication module 222 to provide remote access to the device control routine 304. For example, the web interface 224 may allow a user to remotely view and/or modify one or more variable or subroutines of the device control routine 304.

The automation device 110 may further include a sensor and control package 226 that, in cooperation with the device control routine 304, provides the overall device functionality. For example, if the automation device 110 is a room temperature sensor (RTS) provided by Siemens, then the sensor and control package 226 may be a temperature sensor and the device control routine 304 may be programmed and configured to operate, control and analyze the data gathered and provided by the temperature sensor. In other embodiments, the automation device 110 may be an actuator, drive controller, smoke alarm and any other device configured to operate in and communicate with one or more element and devices within the building automation system 100.

FIG. 3 depicts a functional representation of automation interface 200 and the controller 300 in communication with the automation device 110 and controller 300 via the data connection 214 established between communication modules 212 and 222. In particular, FIG. 3 illustrates that the interface control routine 302 and the device control routine 304 are stored in the memories 206 resident within the automation interface 200 and the automation device 110, respectively. In other words, the memory 206 of the automation interface 200 stores the interface control routine 302 executable by the processor 204 and configured to direct the operation of the automation interface 200; and the memory 206 of the automation device 110 stores the device control routine 304 executable by the processor 204 and configured to direct the operation and functionality of the automation device 110. The control routines 302 and 304 may, in turn, include numerous subroutines, programs and/or software modules that when executed by the respective processors 204 direct the operation of and communication between the automation interface 200 and one or more automation devices 110 (as well as automation devices 104 and 108.)

The interface control routine 302 may include a communication driver 306 and a control routine 308. The control routine 308 can, in turn, include or incorporate a conversion routine 310, a routing table 312 and a queue 313. The communication driver 306 may provide the mechanism by which the processor 204 and the control routine 308 can control and interact with the communication module 212. The control routine 308 and the associated subroutines and functions 310, 312 and 313 can, in turn, control the receipt, handling and rebroadcast of data packets and/or packets from, for example, the automation device 110. The routing table 312 may include a virtual media access control (VMAC) portion and a corresponding BACnet portion. In one embodiment, the VMAC portion may include: a ZigBee short address; a ZigBee long address, a BACnet ZigBee MAC address and a BACnet tunnel cluster endpoint. The BACnet tunnel cluster endpoint defined within the VMAC portion identifies a port address that may be utilized to communicate, i.e., tunnel, BACnet formatted messages over a ZigBee compatible network such as the mesh network 114. The BACnet portion of the routing table 312 may, in turn, include entries that correspond to the entries of the VMAC portion. Accordingly, the BACnet portion, in this example, includes: a BACnet ZigBee short address; a BACnet ZigBee long address, a remote network number and a BACnet tunnel cluster endpoint. The correlation between these two portions of the routing table 312 provides a means by which a packet formatted and/or addressed according to a first network protocol can be reformatted and/or converted into a packet formatted and/or addressed according to a second network protocol.

Similarly, the device control routine 304 may include a communication driver 314 and a supervisory routine 316. The supervisory routine 316 can, in turn, include or incorporate a sensor/control routine 318, an analysis routine 320, a web interface routine 322 and a routing address table 324. The communication driver 314 may provide the mechanism by which the processor 204 and the supervisory routine 316 can interact with the communication module 222. In the present example, the supervisory routine 316 directs the sensor/control routine 318 to collect data and/or generate control outputs. The data or feedback from the operation of the sensor/control routine 318 can, in turn, be received and processed by the analysis routine 320. The results from the sensor/control routine 318 and the analysis routine 320 may, in one embodiment, be provided to one or more automation devices operable on the networks 102, 106 and 114.

In one embodiment, the collected data and/or generated control outputs can be collected and organized by the web interface driver 322 for presentation via the web interface 224. In this way, data and information provided by the sensor/control routine 318 and the analysis routine 320 can be presented and/or accessed remotely on one of the networks 102, 106 and 114.

In another embodiment, the communication routine 314 may be configured to format data and information provided by the sensor/control routine 318 and the analysis routine 320 for communication to another automation device. For example, the data and information can be formatted according to the BACnet messaging standard and utilizing a MS/TP network protocol such as BACnet MS/TP (see FIG. 1) for communication. In this embodiment, the communication routine 314 may access or query the routing address table 324 to determine a destination address for one or more of the automation devices 104, 108 and/or 110. In this instance, the destination address stored in the routing address table 324 will comply and provide the information necessary to identify an MS/TP compliant automation device. Once the packet had been configured with a data envelope containing the destination address in a proper MS/TP format and a message including the data and information provided by the sensor/control routine 318 and the analysis routine 320, the communication routine 314 and communication module 222 can transmit the packet via the data connection 214.

The interface and device control routines 302 and 304 may be a self-contained program or firmware that includes all the information, functions and libraries necessary for the operation of the automation interface 200 and automation device 110, respectively. Alternatively, the interface and device control routines 302 and 304 may utilize one or more application-programming interface (API) stored in, for example, the memory 206 to access and utilize information, functions and libraries accessibly stored on the storage module 210. The interface and device control routines 302 and 304 may further include or access one or more drivers to communicate information and data between, for example, the processor 204 or other peripheral devices.

The communicated packet can be received at the communication module 212 of the automation interface 200 via the data connection 214. The interface control routine 302 receives the BACnet messaging standard formatted packet from the communication module 212. In this exemplary embodiment, the interface control routine 302 cooperates with the communication driver 306 to strip away the original MS/TP network protocol format of the packet and replace it with a new ZigBee (IEEE 802.15.4) network protocol format. The interface control routine 302 queries the routing table 312 based on the destination address contained within the data envelope to determine if there is a corresponding destination address on the ZigBee network. If a corresponding destination address is not found, the interface control routine 302 may broadcast a request for identification to the devices operating on any of the communicatively connected networks 102, 106 and 114. For example, the request for identification may be a Whols request on a TCP/IP configured network, a MatchProcessAddress request on a ZigBee configured network or any other known or later developed discovery request. The broadcasted request may be a request for a specific address corresponding to a desired device or a generalized request to any device receiving the communication. For example, the broadcast can utilize a wildcard to search for all addresses in communication with the automation interface 200. In another embodiment, the broadcast could trigger one or more receiving devices to communicate a local routing table (not shown) to the automation interface 200. In this way, the response or responses can be stored by the interface control routine 302 and used to populate the routing table 312. Once the destination address on the ZigBee network is determined, the interface control routine 302 can communicate the newly formatted data envelope and packet to intended device operable on the mesh network 114 via the communication module 212.

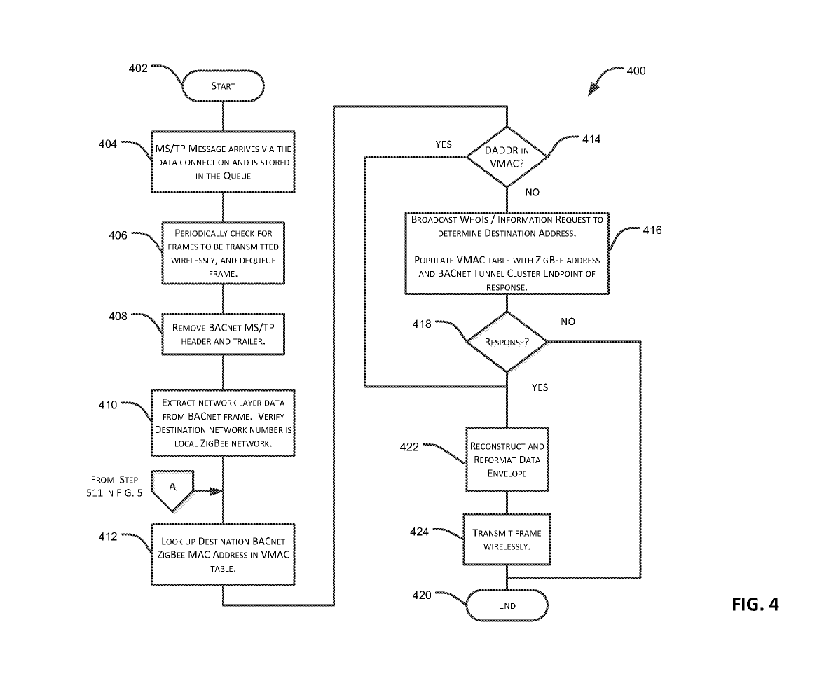

FIGS. 4 to 7 illustrate different operational configurations that may be implemented with the automation interface 200 and the teaching disclosed herein.

### I. Outbound Communication Handling Via the Automation Interface

FIG. 4 depicts a flowchart 400 that describes a specific configuration of automation interface 200 and automation device 110 discussed generally above. In particular, the present example relates to and further expands upon the above-described configuration that includes the automation interface 200b coupled to, and in communication with, the automation device 110a. In this example, the automation device 110a is a BACnet MS/TP device coupled to the BACnet ZigBee configured automation interface 200b.

In operation, the interface control routine 302 of the automation interface 200b is active and configured to exchange packets of data and information with the automation device 110a via the communication modules 212, 222 coupled along the data connection 214 (starts at step 402). The interface control routine 302, in response to receiving a BACnet MS/TP formatted packet from the automation device 110a via the communication module 212 and/or the communication driver 306, stores the received packet in the queue 313 defined within the memory 206 (step 404). Periodically, the interface control routine 302 queries the queue 313 to determine the presence of a packet to be transmitted by the wireless transceiver 212b portion of the communication module 212 (step 406).

Detection of the BACnet MS/TP formatted packet awaiting wireless transmission within the queue 313 causes the interface control routine 302 to activate the conversion routine 310. The conversion routine 310, in turn, evaluates and removes the header and trailer information from the data envelope portion of the packet (as well as the associated destination address) while leaving the BACnet message portion of the packet unchanged (step 408). The interface control routine 302 of the automation interface 200b utilizes the removed data envelope information to verify that the remote network number stored in the BACnet portion of the routing table 312 corresponds to a destination BACnet ZigBee MAC address operable within a BACnet ZigBee network (step 410). For example, each of the network protocols such as IP, Ethernet, ZigBee, MS/TP, and Arcnet that may be utilized according to the BACnet standard is assigned a unique network number that accompanies the unique destination MAC address associated with a given device. By utilizing the combination of the network number and the unique MAC address, each device can address and communicate with another device on any of the networks 102, 106 and 114 regardless of the network protocols implemented by the various devices (and networks). Upon verification of the necessary addressing information, the interface control routine 302 queries the VMAC portion of the the routing table 312 to determine if the MS/TP formatted destination address corresponds to MAC address of the destination ZigBee device (step 412).

If a destination MAC address is not found in the VMAC portion of the routing table 312 at step 414, the interface control routine 302 may initiate a Whols or other information request broadcast across the mesh network 114 to search for the destination address and BACnet tunnel cluster endpoint to populate the VMAC portion of the routing table 312 (step 416). If a destination address is not found at step 418, the packet is dropped by the control interface routine 302 and communication is ended (step 420). However, if the destination MAC address is found, or returned via the information request, then the data envelope is reconstructed and/or reformatted by the interface control routine 302 utilizing the new destination address (step 422). In this way, the MS/TP network protocol portion of the packet formatted according to the BACnet standard may be replaced with the ZigBee network protocol. Upon completion of the conversion routine 310, the interface control routine 302 utilizes the communication driver 306 to wirelessly transmit the reformatted packet (including the original BACnet message) via the wireless transceiver 212b (step 424).

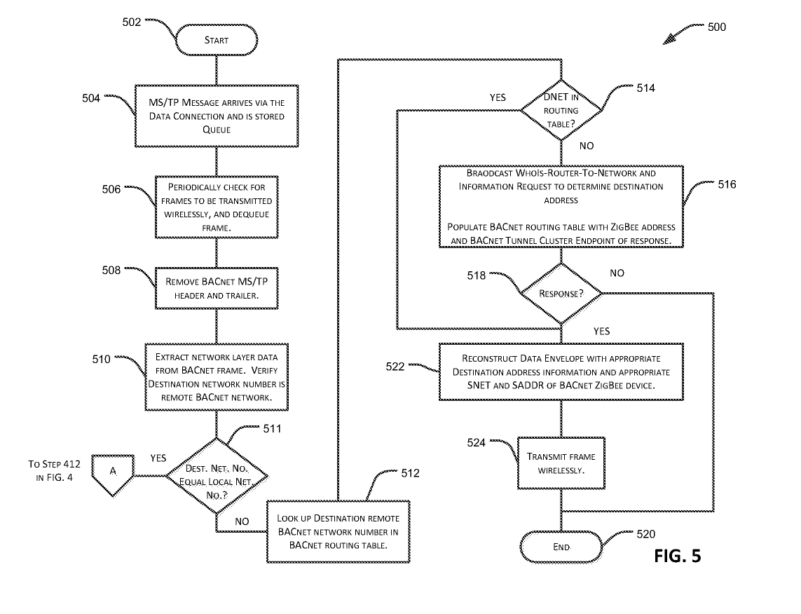

FIG. 5 depicts a flowchart 500 that describes a configuration in which the coupled automation interface 200b and automation device 110a are configured to communicate with another automation device such as the automation interface 200a or one of the automation devices 104 operable on the BACnet IP configured network 102.

In the exemplary operation, the interface control routine 302 is active and configured to exchange packets of data and information with the automation device 110a via the communication modules 212, 222 coupled along the data connection 214 (starts at step 502). Upon receipt of a BACnet MS/TP formatted packet from the automation device 110a, the interface control routine 302 stores the packet in the queue 313 defined within the memory 206 (step 504). The interface control routine 302 periodically queries the queue 313 to determine the presence of a packet to be transmitted by the wireless transceiver 212b portion of the communication module 212 (step 506).

Once a BACnet MS/TP formatted packet is detected in the queue 313, the interface control routine 302 activates the conversion routine 310 to strip the header and trailer information from the data envelope portion of the packet (step 508). The destination address and the BACnet message portion of the packet are retained once the header and trailer information has been removed from the packet by the conversion routine 310. The removed data envelope information may be utilized by the interface control routine 302 to verify that the destination network number associated with the destination address corresponds to the remote BACnet network number (step 510). If the destination network number is determined to equal the local ZigBee network number (step 511), then the interface control routine 302 of the automation interface 200b directs the received packet to a destination BACnet ZigBee MAC address operable within a BACnet ZigBee network (see step 412). However, if the destination network number does not equal a local ZigBee network number, then the interface control routine 302 queries the BACnet portion of the routing table 312 to determine the destination or remote network information associated with the destination BACnet network (step 512).

If the destination or remote network information is not found in the BACnet portion of the routing table 312 at step 514, the interface control routine 302 may initiate a search or other information request broadcast across the mesh network 114 in an attempt to determine the BACnet ZigBee address and BACnet tunnel cluster endpoint from one or more of the automation devices 110 and/or automation interfaces 200b operable thereon. In this example, the request broadcast could be a Whols-Router-To-Network request to identify the automation interface 200a and 200c that contains and stores the necessary destination network information. The responses to the search may be used by the interface control routine 302 to populate the BACnet portion of the routing table 312 (step 516). If no response or destination information is found at step 518, the packet is dropped by the interface control routine 302, which then sends an undeliverable message to the automation device 110a and/or automation interface 200b before ending the communication as shown at step 520. However, if the destination address is found, or returned via the search, then the data envelope is reconstructed and/or reformatted by the interface control routine 302 utilizing the determined destination address and a sender address and network corresponding to the automation interface 200b (step 522). In this way, the original MS/TP network protocol portion of the packet may be replaced with the ZigBee network protocol and the BACnet standard message portion of the packet can be communicated to the correct BACnet tunnel cluster endpoint operable on the mesh network 114. Upon completion of the conversion routine 310, the interface control routine 302 utilizes the communication driver 306 and the communication module 212 to wirelessly transmit the reformatted packet (including the original BACnet message) via the wireless transceiver 212b to the automation interface 200c which, in turn, forwards the received message to one of the automation device 104 operable on the BACnet IP configured network 102 (step 524).

### II. Inbound Communication Handling Via the Automation Interface

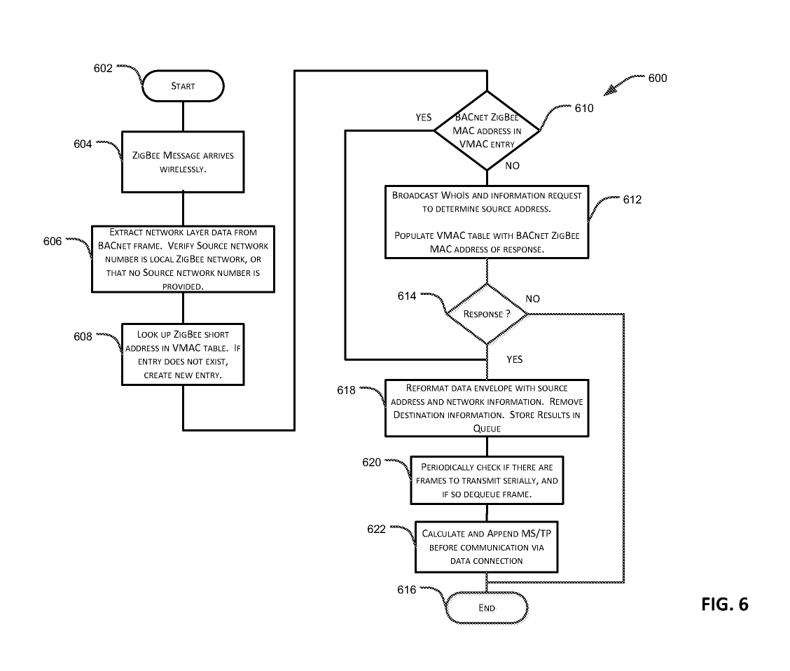

FIG. 6 depicts a flowchart 600 that describes a configuration in which the coupled automation interface 200b and automation device 110a are configured to receive a communication from another automation device such one of the automation devices 110 operable on the BACnet ZigBee configured network 114 (step 602).

Upon receipt of a BACnet ZigBee formatted packet via the wireless transceiver 212b (step 604), the data envelope information included in the formatted packet may be utilized by the interface control routine 302 to verify that a source network number contained within the data envelope corresponds to the BACnet ZigBee network 114 (step 606).

The interface control routine 302 queries the VMAC portion of the routing table 312 to determine the ZigBee short address corresponding to the source or originating automation device that generated or provided the received BACnet ZigBee formatted packet; and if one does not exist, then the control routine 302 can create a new entry within the routing table 312 (step 608). Next, the interface control routine 302 queries the VMAC portion of the routing table 312 to determine the BACnet ZigBee MAC address that corresponds to the ZigBee short address. If the BACnet ZigBee MAC address is not identified in the VMAC portion of the routing table 312 (step 610), the interface control routine 302 may initiate a Whols or other information request broadcast across the mesh network 114 in an attempt to determine the BACnet ZigBee MAC address that represents the source address. The responses to the search may be used by the interface control routine 302 to populate the VMAC portion of the routing table 312 (step 612). If no response or destination information is found (step 614), the packet is dropped by the interface control routine 302 before communication is ended as shown at step 616. However, if the BACnet ZigBee MAC address is found, or returned via the search, then the data envelope is reconstructed by the interface control routine 302 as an MS/TP data envelope utilizing the determined source address information from the BACnet ZigBee MAC address in place of the received destination information (step 618). The resulting MS/TP formatted packet can be stored in the queue 313 (step 620) for transmission to the automation device 110a via communication module 212 and the data connection 214 (step 622). At the time of transmission, a cyclic redundancy check (CRC) may be calculated and appended to the MS/TP formatted packet by the interface control routine 302.

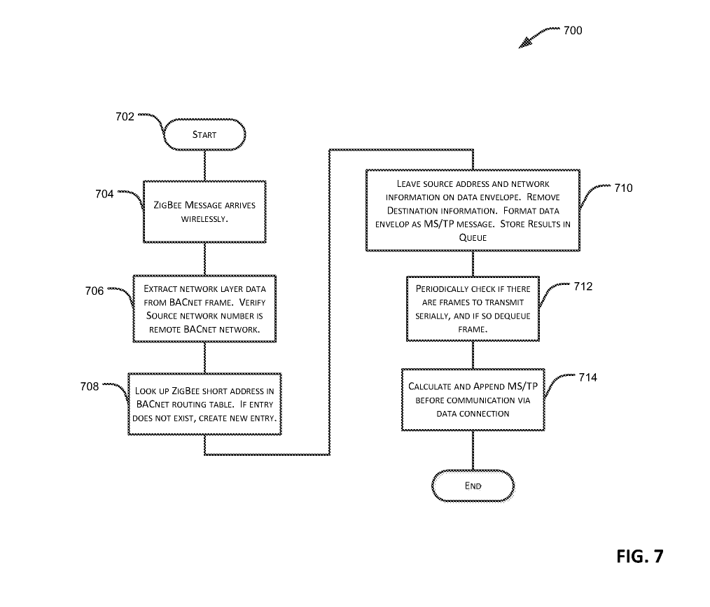

FIG. 7 depicts a flowchart 700 that describes a configuration in which the coupled automation interface 200b and automation device 110a are configured to receive a communication from another automation device operable on the BACnet IP configured network 102 (starts at step 702). Upon receipt of a BACnet ZigBee formatted packet via the wireless transceiver 212b (step 704), the data envelope information included in the formatted packet may be utilized by the interface control routine 302 to verify that a source network number contained within the data envelope corresponds to the BACnet IP network 102 (step 706).

The interface control routine 302 queries the BACnet portion of the routing table 312 to determine the ZigBee short address corresponding to the source or originating automation device of the BACnet ZigBee formatted packet; and if one does not exist, then the control routine 302 can create a new entry within the routing table 312 (step 708). Next, the interface control routine 302 reconstructs the data envelope as an MS/TP data envelope utilizing the source address information from the BACnet IP formatted packet provided by the source automation device (step 710). The resulting MS/TP formatted packet can be stored in the queue 313 (step 712) for transmission to the automation device 110a via communication module 212 and the data connection 214 (step 714). At the time of transmission, a cyclic redundancy check (CRC) may be calculated and appended to the MS/TP formatted packet by the interface control routine 302.

Herein, the phrases “coupled with”, “in communication with” and “connected to” are defined to mean components arranged to directly or indirectly exchange information, data and commands through one or more intermediate components. The intermediate components may include both hardware and software based components. Moreover, the phrase “operatively coupled” is defined to mean two or more devices configured to share resources or information either directly or indirectly through one or more intermediate components.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be substantially minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

What is claimed is:

1. An automation interface device configured to provide interoperability between two or more automation devices communicating within a building automation system, the device comprising:
a communication interface configured to receive a packet comprising a data envelope including a first destination address configured according to a first network protocol and a message including data configured according to a BACnet standard;
a processor in communication with a memory, wherein the memory stores processor executable instructions configured to:
retrieve a second destination address from a routing table stored in the memory, wherein the second destination address is configured according to a second network protocol and wherein the second destination address correlates to the first destination address;
generate a second packet comprising an second data envelope including the second destination address configured according to the second network protocol and the message including data configured according to the BACnet standard; and
communicate, via the communication interface, the second packet to the second destination address.

2. The device of claim 1, wherein the first network protocol is selected from the group consisting of: a BACnet Master-Slave/Token-Passing (MS/TP) protocol; a BACnet ZigBee (IEEE 802.15.4) protocol and a BACnet Internet Protocol (IP).

3. The device of claim 2, wherein the first network protocol is different from the second network protocol and, wherein the second network protocol is selected from the group consisting of: a BACnet Master-Slave/Token-Passing (MS/TP) protocol; a BACnet ZigBee (IEEE 802.15.4) protocol and a BACnet Internet Protocol (IP).

4. The device of claim 1, wherein the processor executable instructions are further configured to:
broadcast, via the communication interface, a request for identification according to the second network protocol.

5. The device of claim 4, wherein the processor executable instructions are further configured to:
populate the routing table based on one or more response to the broadcast request for identification; and
generate, if no response is received, an error message.

6. A method of interfacing between two or more automation devices communicating within a building automation system, the method comprising:
receiving a packet comprising a data envelope including a first destination address configured according to a first network protocol and a message including data configured according to a BACnet standard;
determining a second destination address from a routing table stored in the memory, wherein the second destination address is configured according to a second network protocol and wherein the second destination address correlates to the first destination address;
generating a second packet comprising a second data envelope including the second destination address configured according to the second network protocol and the message including data configured according to the BACnet standard; and
communicating, via the communication interface, the second packet to the second destination address.

7. The method of claim 6, wherein the first network protocol is selected from the group consisting of: a BACnet Master-Slave/Token-Passing (MS/TP) protocol; a BACnet ZigBee (IEEE 802.15.4) protocol and a BACnet Internet Protocol (IP).

8. The method of claim 7, wherein the first network protocol is different from the second network protocol and, wherein the second network protocol is selected from the group consisting of: a BACnet Master-Slave/Token-Passing (MS/TP) protocol; a BACnet ZigBee (IEEE 802.15.4) protocol and a BACnet Internet Protocol (IP).

9. The method of claim 6 further comprising:
broadcasting a request for identification according to the second network protocol.

10. The method of claim 6 further comprising:
populating the routing table based on one or more response to the broadcast request for identification; and
generating, if no response is received, an error message.

11. A method of interfacing between automation devices communicating within a building automation system, the method comprising:
receiving a packet from a first automation device at an automation interface device, the packet comprising a data envelope including a first destination address configured according to a first network protocol and a message including data configured according to a BACnet standard;
determining, at the automation interface device, a second destination address identifying a second automation device, wherein the second destination address is configured according to a second network protocol and wherein the second destination address correlates to the first destination address;
generating, at the automation interface device, a second packet comprising an second data envelope including the second destination address configured according to the second network protocol and the message including data configured according to the BACnet standard; and
communicating the second packet to the second automation interface device at the second destination address.

12. The method of claim 11, wherein the first network protocol is selected from the group consisting of: a BACnet Master-Slave/Token-Passing (MS/TP) protocol; a BACnet ZigBee (IEEE 802.15.4) protocol and a BACnet Internet Protocol (IP).

13. The method of claim 12, wherein the first network protocol is different from the second network protocol and, wherein the second network protocol is selected from the group consisting of: a BACnet Master-Slave/Token-Passing (MS/TP) protocol; a BACnet ZigBee (IEEE 802.15.4) protocol and a BACnet Internet Protocol (IP).

14. The method of claim 11 further comprising:
broadcasting, via the automation interface, a request for identification according to the second network protocol.

15. The method of claim 14 further comprising:
populating the routing table based on one or more response to the broadcast request for identification; and
generating, if no response is received, an error message.

16. A method of interfacing between two or more automation devices communicating within a building automation system, the method comprising:
receiving a data envelope including a first destination address configured according to a BACnet MS/TP network protocol and a message including data configured according to a BACnet standard;
retrieving a second destination address configured according to a BACnet ZigBee network protocol from a routing table, wherein the second destination address correlates to the first destination address;
generating a second data envelope including the second destination address and the message including data configured according to the BACnet standard; and
communicating, via the communication interface, the second data envelope to the second destination address.

17. The method of claim 16, wherein determining the second destination further comprises:
broadcasting a request for identification according to the BACnet ZigBee network protocol.

18. The method of claim 17 further comprising:
populating the routing table based on one or more response to the broadcast request for identification; and
generating, if no response is received, an error message.
